(19) United States
(12) Patent Application Publication
(10) Pub. No.: US 2026/0164306 A1
(43) Pub. Date: Jun. 11, 2026

(54) PROACTIVE NETWORK LOAD MANAGEMENT

(71) Applicant: T-Mobile USA, Inc., Bellevue, WA (US)

(72) Inventor: Vasu Krishnasami, Bellevue, WA (US)

(21) Appl. No.: 18/970,381

(22) Filed: Dec. 5, 2024

(51) Int. Cl. H04W 28/08; H04W 28/02

(52) U.S. Cl. CPC H04W 28/0942; H04W 28/0289

(57) ABSTRACT

A network function in a core network receives information about the capacity of the Unified Data Repository (UDR), which is associated with two core network applications. The network function obtains traffic data for both the first and second core network applications. The network function determines the traffic volumes for each application, ensuring the total does not exceed the UDR’s capacity. The network function transmits the calculated traffic volumes to the respective core network applications. Each application throttles traffic that exceeds its allocated volume to prevent overloading the UDR.

### BACKGROUND

A core network is a part of a computer network which interconnects networks, providing a path for the exchange of information between different local area networks (LANs) or subnetworks. A core network can tie together diverse networks in the same building, in different buildings in a campus environment, or over wide areas. A Unified Data Repository (UDR) within the core network serves as a centralized data repository for subscription data, subscriber policy data, sessions, contexts, and application states. The UDR provides standard-based API integrations with other network functions (UDM, PCF, and others) to retrieve subscriber subscription and policy data. The UDR can be overwhelmed when it receives an excessive volume of data traffic from network functions within the core network. The influx of data can occur during periods of heightened network activity, such as during peak usage times, when multiple network functions (NFs) simultaneously send requests to the UDR, or when outages in some parts of a network push higher traffic loads to a subset of NFs in the network. The NFs may generate traffic for various purposes, including subscriber authentication, session management, or data retrieval.

### BRIEF DESCRIPTION OF THE DRAWINGS

Detailed descriptions of implementations of the present technology will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example environment for a network load-balancing system that can implement aspects of the present technology.

FIG. 4A is a block diagram that illustrates an example environment for managing network load by evaluating the capacity of a single application.

FIG. 4B is a block diagram that illustrates an example environment for managing network load by evaluating the capacities of multiple applications.

FIG. 5 is a flowchart illustrating the process of indicating the capacity of the network to the network components that can implement aspects of the present technology.

FIG. 6 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology can address network congestion and overload within core network environments. In telecommunications systems, core networks route and manage data traffic between various network elements. However, in traditional methods of resource management, the capacity of data repositories (e.g., such as Unified Data Repositories (UDRs)) is not communicated to the Network Functions (NFs) responsible for assigning traffic. This lack of communication can lead to inefficient resource utilization and potential overload scenarios within the UDRs. During peak usage periods or unexpected spikes in demand, core networks can become overwhelmed with traffic, leading to congestion and performance degradation. This congestion not only affects the quality of service for end-users but also places strain on network components and resources, potentially leading to service outages or disruptions. Traditional approaches to managing network congestion often rely on reactive measures, such as increasing bandwidth capacity. While these methods may alleviate congestion in the short term, they may not provide a sustainable solution for managing network overload, especially in a dynamic network environments. Additionally, existing congestion management strategies may focus on the congestion state of individual network elements or applications, rather than providing a holistic view of network congestion across all components.

For example, in a telecommunications network where UDMs manage subscriber authentication and UDRs store subscriber profiles and session details, during peak usage periods, the network experiences a surge in user activity, resulting in a significant increase in authentication requests and data transactions handled by UDMs and UDRs. While UDMs may effectively handle the authentication workload without becoming overloaded as the independent capacities are communicated to other network functions, UDRs may struggle to store and retrieve subscriber profiles and session details efficiently if the only capacity considered by the network functions in the network is that of the UDMs. As a result, since there is no proactive method of preventing the UDR from overloading, the UDR may become overloaded and experience congestion and performance degradation, impacting the overall responsiveness of the network. End-users may experience delays in authentication processes or slower data access speeds, impacting their overall experience. The strain placed on UDM and UDR components may increase the risk of service outages or disruptions.

The disclosed technology relates to managing network traffic within a core network environment. A network function of the core network receives information indicating the capacity of a UDR associated with multiple core network applications. Upon receiving this information, the network function can obtain traffic data for each of these applications. Using the capacity of the UDR as a reference point, the network function determines the appropriate volume of traffic data for each application, ensuring that the combined volume does not exceed the capacity of the UDR. The network function transmits the calculated traffic volumes to their respective core network applications. If the volume of traffic exceeds the predefined threshold for a particular application, the core network application throttles the incoming traffic to maintain a manageable workload.

In some implementations, the method prevents the transmission of additional traffic data to a core network application if the core network application’s determined volume already matches the core network application’s capacity. Additionally, the method can prioritize traffic transmission based on the nature of the core network applications involved. For instance, if one application operates on a 5G network while another functions on a 4G network, the system prioritize traffic data for the 5G application over the 4G application.

In some implementations, the method monitors other NFs within the core network for periodic signals exchanged among them. The monitoring process allows the system to detect any irregularities or deviations from expected behavior, indicating potential issues or bottlenecks within the network. Upon detecting these signals, the system can verify the ability of the network functions associated with the signals to handle incoming network communications effectively to address potential network congestion or performance degradation before they impact the overall network functionality.

By enabling the network functions to receive information about the UDR’s capacity, the system ensures that traffic assignments are made with an understanding of the actual resource constraints (e.g., within the UDR). This proactive communication helps prevent congestion by distributing traffic in a manner that avoids overloading the UDRs, thereby maintaining network performance and reliability, especially during peak usage periods or unexpected spikes in demand. By addressing the root causes of congestion through communication between the UDR and other network functions, the technology provides a more sustainable solution to network congestion and overload.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

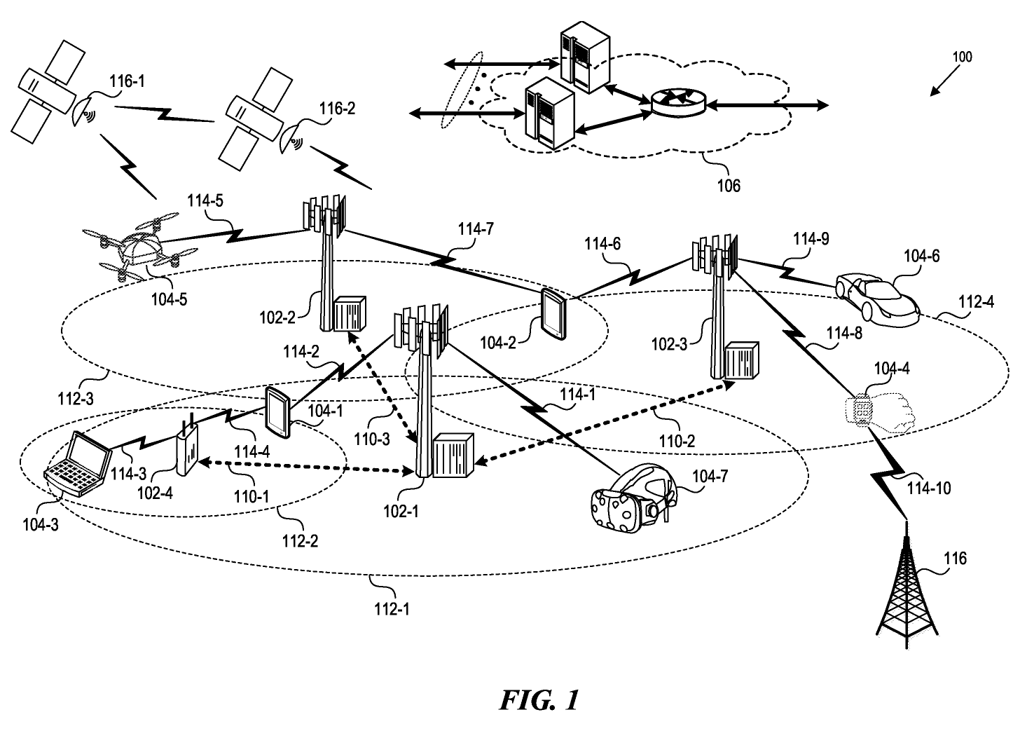

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

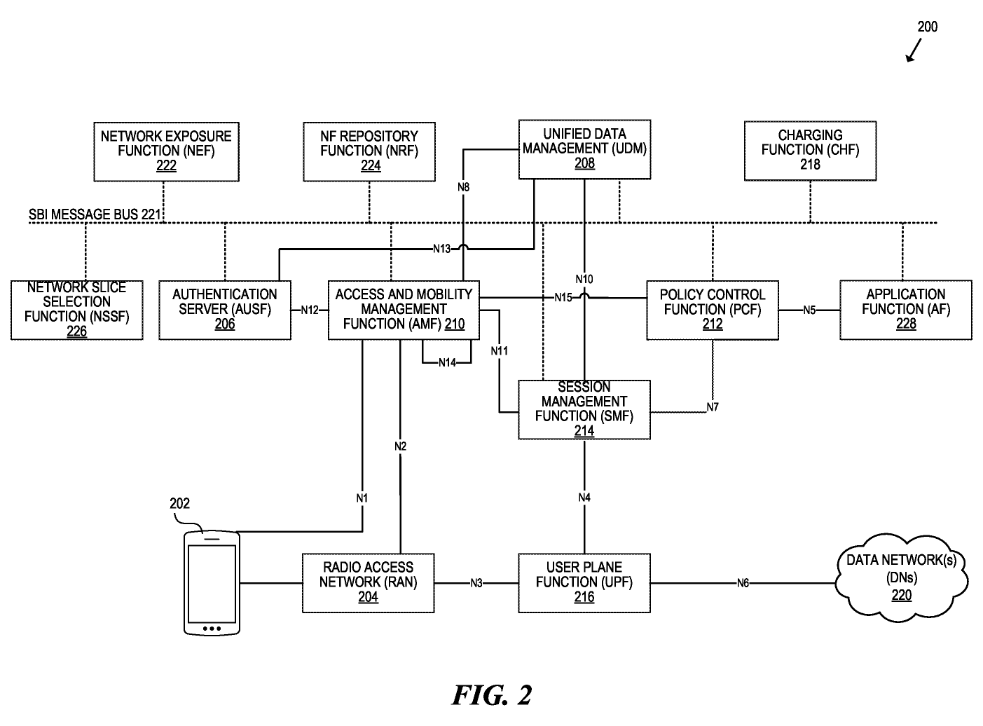

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a data center, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Network Load Management System

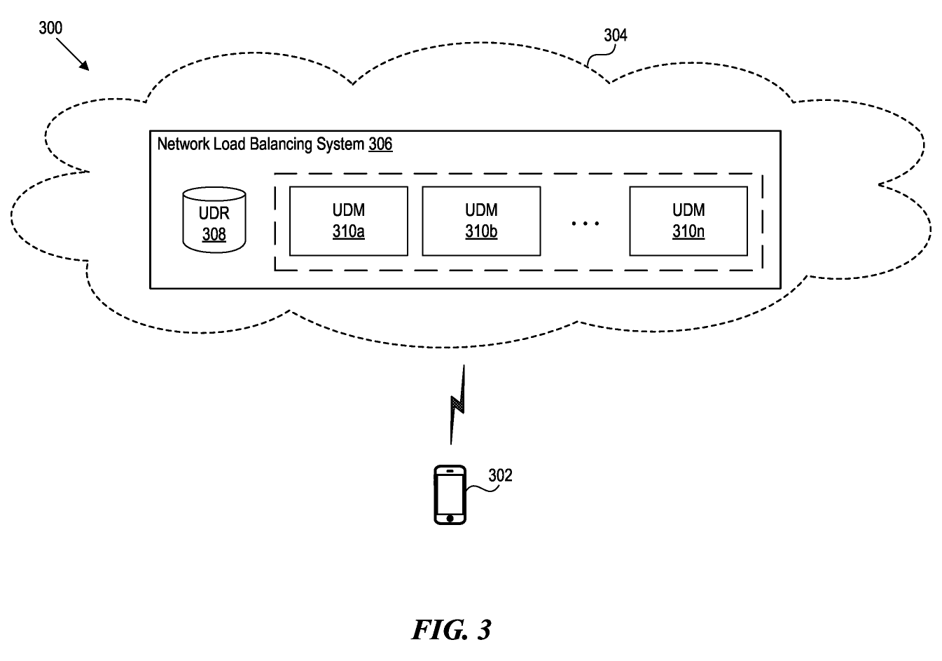

FIG. 3 is a block diagram that illustrates an example environment 300 for a network load-balancing system 306 that can implement aspects of the present technology. Environment 300 includes user equipment (UE) 302, network 304, network load balancing system 306, Unified Data Repository (UDR) 308, and a set of NFs, such as Unified Data Managements (UDMs) 310a-n. UE 302 is the same as or similar to wireless device 104 illustrated and described in more detail with reference to FIG. 1. Network 304 is the same as or similar to network 100 illustrated and described in more detail with reference to FIG. 1. UDMs 310a-n are the same as or similar to UDM 208 illustrated and described in more detail with reference to FIG. 2, and can represent, for example, different instances of a telecommunication network’s UDM network function that operate in different geographic areas. Likewise, implementations of example environment 300 can include different and/or additional components or can be connected in different ways. For example, the load-balancing system 306 can be used to balance loads between other instances of NFs of the telecommunications network or between multiple NFs that share the same UDR.

UE 302 (e.g., wireless devices) includes any electronic device that can communicate and transmit data over the telecommunications network 304. Network 304 includes various network nodes, routers, and switches that manage and route the data traffic. UE 302 uses wireless communication technologies such as Wi-Fi, Bluetooth, cellular networks (e.g., 5G, LTE), infrared, or satellite signals to exchange information with other devices or networks. These devices generate traffic and data requests that are routed through the network 304 to various network functions (NFs) and data repositories. Examples of wireless devices include smartphones, tablets, laptops, smartwatches, fitness trackers, IoT devices, and various sensors.

Network load-balancing system 306, which can be within the telecommunications network 304, dynamically distributes network traffic across multiple instances of NFs and data repositories to prevent any single component from becoming overwhelmed. By monitoring real-time traffic loads and network conditions, network load-balancing system 306 can make informed decisions to reroute traffic, thereby better allocating network resources and improving overall network performance. The network load-balancing system 306 analyzes the current state of network 304, including the capacities and current loads of various NFs (e.g., UDMs 310a-n) and data repositories (e.g., UDR 308). Network load-balancing system 306 uses this information to reroute traffic as necessary, distributing the traffic to avoid overloading any single core network application (e.g., NF). For example, if one NF is approaching its capacity, network load-balancing system 306 can redirect some of the NF’s traffic to other, less burdened NFs. Similarly, if a data repository such as UDR 308 begins to receive too much traffic data from the core network applications (e.g., NFs), network load-balancing system 306 can adjust the flow of traffic data to maintain a balanced load and prevent the UDR from overloading.

UDR 308 stores and manages subscriber-related data, such as user profiles, authentication information, and session details. The UDR ensures that the subscriber-related data is accessible to various NFs (e.g., UDMs 310a-n), supporting services and features. This includes user profiles, authentication information, session details, and other essential data required for the operation of various network functions (NFs). The UDR acts as a centralized data repository, ensuring that subscriber data is organized, accessible, and secure. The UDR can provide NFs with the necessary information to perform tasks such as user authentication, policy enforcement, and/or session management. For example, when a subscriber initiates a session or makes a network request, the relevant NF queries the UDR to retrieve the necessary subscriber information. The UDR responds and provides the NF with accurate data to facilitate the requested service. Given the volume and sensitivity of the data it handles, it is important that UDR 308 is not overloaded in the UDR’s 308 capacity to maintain the quality of service.

UDMs 310a-n each represent a UDM that communicates with the UDR 308. The UDMs 310a-n are responsible for managing and processing subscriber data, which can involve tasks such as authentication, authorization, and/or policy enforcement. For example, when a subscriber attempts to access the network 304, the UDM verifies their identity using data stored in UDR 308 by checking credentials and other authentication parameters to ensure that only legitimate users can access network services. Once a subscriber is authenticated, UDR 308 can determine what services and resources the subscriber is allowed to access based on predefined policies. UDMs 310a-n enforce these policies to ensure that subscribers can only access services they are entitled to, thereby maintaining order and efficiency within the network. Policy enforcement also includes managing quality of service (QoS) parameters, which help prioritize network traffic and ensure a consistent user experience.

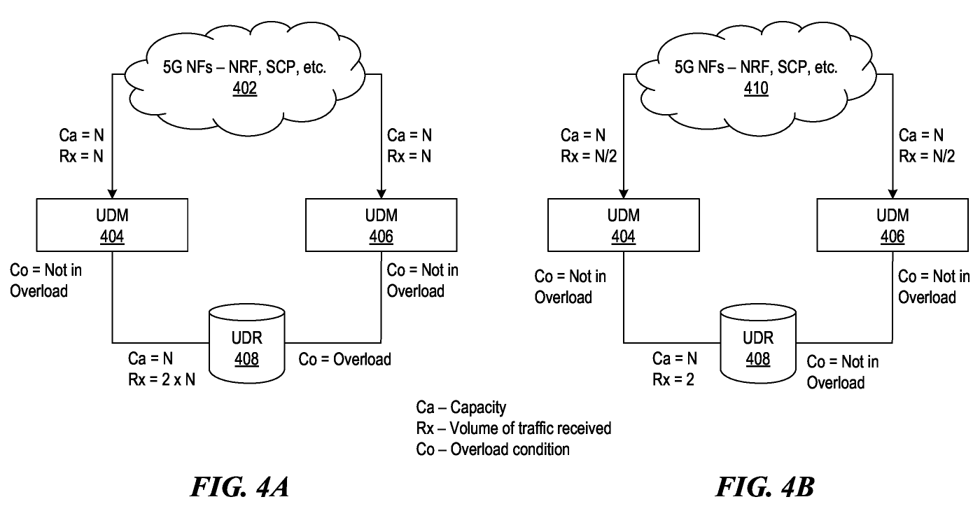

FIG. 4A is a block diagram that illustrates an example environment 400 for managing network load by evaluating the capacity of a single application. Environment 400 includes NF 402, 410 UDM 404, 406, and UDR 408. NF 402 is the same as or similar to AUSF 206, UDM 208, AMF 210, PCF 212, SMF 214, UPF 216, and CHF 218 illustrated and described in more detail with reference to FIG. 2. UDM 404, 406 is the same as or similar to UDM 208 and UDM 310a-n illustrated and described in more detail with reference to FIG. 2 and FIG. 3, respectively. UDR 408 is the same as or similar to UDR 308 illustrated and described in more detail with reference to FIG. 3. Likewise, implementations of example environment 400 can include different and/or additional components or can be connected in different ways.

In FIG. 4A, UDM 404 and UDM 406, which both can handle requests from NF 402, each have a capacity of N. In the figure, UDM 404 and UDM 406 can operate independently and each receive a volume of requests equal to their capacity, N, from NF 402. Because each UDM is only handling requests within its capacity, neither UDM 404 nor UDM 406 experiences overload. However, UDR 408, which serves as the central data store for both UDMs 404, 406, also has a capacity of N. UDR 408 is responsible for responding to data queries and storing the subscriber data required by UDM 404 and UDM 406 to process their respective requests. Further capabilities of UDR 408 are discussed with reference to FIG. 2 and FIG. 3.

In FIG. 4A, UDR 408 receives N requests from UDM 404 and an additional N requests from UDM 406. The cumulative volume of requests received by UDR 408 exceeds UDR’s 408 capacity limit, potentially leading to overload conditions. Since UDR 408 receives a combined total of 2N requests, doubling the UDR’s 408 intended capacity, as a result, UDR 408 becomes overloaded, even though each UDM 404, 406 is functioning within its designated capacity. The overload condition at the UDR 408 means that the UDR 408 struggles to process and respond to the incoming data requests to the network efficiently. This can lead to significant delays, increased latency, and potential data access failures for the users.

Without proper load management, UDR 408 may struggle to process the influx of requests efficiently, resulting in performance degradation or service disruptions. The cascading effect of the UDR’s 408 overload is detrimental to the network’s performance. Since the UDR 408 is unable to handle the 2N requests promptly, the response times for UDM 404 and UDM 406 increase. These delays propagate back to NF 402 and ultimately affect the UE 302, which may result in a poor user experience characterized by slow data retrieval, dropped calls, and/or failed sessions.

FIG. 4B is a block diagram that illustrates an example environment 400 for managing network load by evaluating the capacities of multiple applications. In FIG. 4B, NF 410 distributes its requests between UDM 404 and UDM 406, for example by sending N/2 requests to each. Given this distribution, UDM 404 and UDM 406 each receive N/2 requests from NF 410. With each UDM receiving N/2 requests, they each query the UDR 408 for data, resulting in the UDR receiving N/2 requests from UDM 404 and another N/2 requests from UDM 406. The combined total of these requests is N.

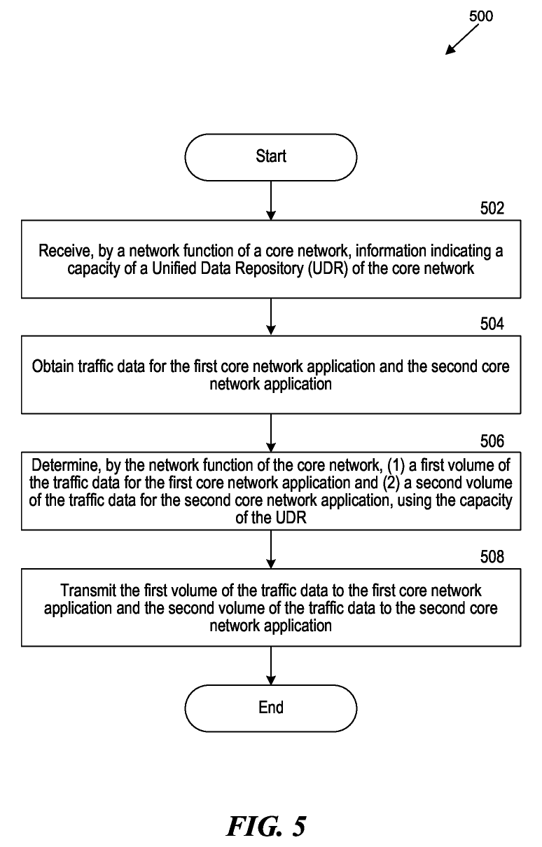

Since the UDR 408 has a capacity of N, it can handle the combined load of N requests from both UDMs without experiencing overload. The UDR 408 processes these requests within its capacity limits, ensuring that data retrieval operations are performed efficiently. This balanced load distribution allows the UDR 408 to function without being in overload, avoiding delays and maintaining high performance. By ensuring that each of the two illustrated UDMs only receives half of the UDR’s capacity in requests, and consequently the UDR 408 receives its full capacity from the combined UDMs, the system prevents any single component from becoming a bottleneck. Methods of distributing the load between the NFs (e.g., UDMs 404, 406) are discussed with reference to FIG. 5.

FIG. 5 is a flowchart illustrating the process 500 of indicating the capacity of the network to the network components that can implement aspects of the present technology. In some implementations, the process 500 is performed by components of example NFs illustrated and described in more detail with reference to FIG. 1 and FIG. 2. Likewise, implementations can include different and/or additional steps or can perform the steps in different orders.

In act 502, the network load management system receives, by a network function (e.g., NF 410 of FIG. 4) of a core network, information indicating a capacity of a UDR (e.g., UDR 408 of FIG. 4) of the core network. The UDR is associated with at least a first core network application (e.g., UDM 404, 406 of FIG. 4) and a second core network application (e.g., UDM 404, 406 of FIG. 4). In some implementations, the network function receives the information from the UDR, the first core network application, and/or the second core network application. The capacity information can be transmitted to network load management system as part of existing communications between the UDR and other components of the telecommunications network or within new signals that are generated for the purpose of conveying the capacity information to the core network. For example, capacity information can be represented within a heartbeat that the UDR transmits at regular intervals.

The information received by the network load management system can be capacity information, which provides insights into the available resources and capabilities of the UDR of the network, allowing the network load management system to make informed decisions regarding resource allocation and load balancing. The capacity of a UDR can be the maximum amount of data storage and processing capabilities available within the repository. Capacity information can include information such as storage capacity, processing speed, and/or concurrent user access limits. In some implementations, the capacity information can be represented as a numerical value that indicates a degree of overload of the UDR. For example, a value of zero indicates that the UDR is not in an overload state and can continue to process requests at a rate that satisfies a service threshold. A value of 20, 20%, 0.2, or the like can indicate that the UDR is receiving requests at a rate that is 20% higher than the rate at which the UDR can maintain the service threshold. Other representations of the UDR’s capacity can additionally or alternatively be provided in the capacity information received by the network load management system, including, for example, numerical values that indicate an amount of additional traffic that can be handled by the UDR, qualitative values that indicate whether the UDR is overloaded or not overloaded, quantitative or qualitative values that indicate a prediction for whether the UDR will be overloaded in the future (and, optionally, by how much the UDR’s traffic will exceed its capacity), etc.

In act 504, the network load management system obtains traffic data for the first core network application and the second core network application. Traffic data can include a broad spectrum of information related to the flow of data packets, requests, transactions, or interactions within the core network environment. For example, traffic data can include requests or data packets transmitted between network elements, such as servers, clients, or network devices.

In act 506, the network load management system determines, by the network function of the core network, (1) a first volume of the traffic data for the first core network application and (2) a second volume of the traffic data for the second core network application, using the capacity of the UDR. The volumes are determined such that a sum of the first volume and the second volume will be less than or equal to the received capacity of the UDR. In some implementations, the determined first volume of the traffic data can be equal to the determined second volume of the traffic data. In some implementations, the determined first volume of the traffic data can be different from the determined second volume of the traffic data.

In some implementations, the first and second volumes are determined based on a predetermined ruleset with predefined criteria, thresholds, and/or policies to allocate resources and prioritize traffic within the core network environment. The predetermined ruleset can ensure that traffic volumes are aligned with operational requirements, performance objectives, and capacity constraints. For example, the ruleset can outline a set of criteria and parameters used to classify and categorize core network applications based on factors such as application type, service level agreements (SLAs), and resource dependencies. Once core network applications are classified and categorized, the ruleset can define thresholds and limits for allocating traffic volumes to each application based on its designated priority and resource requirements. The thresholds can vary depending on network conditions, traffic patterns, and capacity utilization metrics. For example, if a sudden surge in user activity results in a spike in network traffic that crosses a predefined threshold, the predetermined ruleset may trigger a proactive adjustment of traffic volume to different NFs to prioritize essential services such as voice communications or real-time data transmission over less time-sensitive applications like file downloads or software updates, or adjust the volumes of traffic allocated to particular NFs.

In some implementations, the first and second volumes are determined based on a machine learning (ML) model that anticipates and predicts capacity requirements to dynamically allocate traffic to various NFs within the core network environment. ML models can be trained on historical traffic data, performance metrics, and network telemetry to identify patterns, trends, and anomalies, and enable the system to adapt dynamically to changing network conditions. For example, predictive models can be trained on historical traffic data to forecast future demand and capacity requirements. By analyzing historical traffic patterns, seasonality, and trends, the ML model can identify patterns and correlations that inform volume allocation decisions. Through iterative training and refinement, the model continuously learns and adapts to evolving network dynamics, improving the model’s predictive accuracy and reliability over time.

In some implementations, if the determined first volume of the traffic data is equal to a capacity of the first core network application, network load management system prevents transmission of additional traffic data from the network function to the first core network application. For example, if the network load management system determines that the volume of incoming requests already matches a core network application’s capacity threshold, no additional requests are forwarded to the application. Instead, the network load management system can redirect the excess requests to other available core network applications or queues them for processing during periods of lower demand. By proactively managing traffic volumes and enforcing capacity limits, the network load management system can prevent individual applications from becoming overwhelmed.

Some UDRs are associated with more than two core network applications. In these cases, the network load management system determines traffic volumes for each of the multiple core network applications that use the UDR such that the traffic of the multiple applications together is less than or equal to the capacity of the UDR. The traffic volumes for three or more applications can be determined in a similar manner as described above for two-application traffic volumes.

In some implementations, the UDR is deployed with redundant NF instances to enable continuous service availability (i.e., the network load management system contains redundant NF instances). For example, the deployment configuration can be implemented in an active/standby or active/active configuration. In an active/standby configuration, one or more NF instances can actively route all traffic to the core network applications while one or more standby NF instances remains idle but configured to take over in case the active instance fails to decrease disruption to the network services and maintain the availability of subscriber data and other NFs. On the other hand, in an active/active configuration, all NF instances can operate simultaneously to share the traffic load. An active/active configuration can improve fault tolerance and performance by distributing the tasks across multiple instances. Each NF instance in an active/active setup can handle a portion of the total traffic, thereby reducing the load on individual instances and preventing any single point of failure, delays, and/or performance degradation.

The UDR can calculate the load level of the entire deployment, not just the local NF instance. Thus, the UDR can monitor and manage the traffic distribution across all instances so that no single instance becomes a bottleneck. The UDR can use various metrics, such as CPU usage, memory utilization, and network bandwidth, to assess the load on each NF instance and use the metrics to determine traffic routing and load balancing related decisions. For example, if one instance is nearing its capacity, the UDR can proactively redistribute traffic to other instances with available capacity, to prevent overload and maintaining optimal performance. In some implementations, the UDR can anticipate periods of high demand and allocate/redistribute resources in advance to handle the expected load (e.g., during peak usage times or unexpected traffic surges).

In act 508, the network load management system transmits the first volume of the traffic data to the first core network application and the second volume of the traffic data to the second core network application. The first core network application throttles traffic through the first core network application that is above the first volume of the traffic data. The second core network application throttles traffic through the second core network application that is above the second volume of the traffic data.

Throttling refers to the deliberate control or regulation of the flow of data, requests, or traffic within a network to manage congestion, prevent overload, and/or ensure performance. Throttling can involve imposing limits or restrictions on the rate at which data is transmitted or processed, such as slowing down or regulating the pace of data transfer to align with predefined thresholds or capacity limits. For example, the core network applications can set a maximum rate at which data can be transmitted or processed within the network. Requests or data packets that exceed this rate are either delayed, queued for later processing, or discarded to prevent congestion and maintain stable performance. The core network applications can also assign different priorities to incoming data or requests based on their importance or urgency. More time-sensitive traffic, such as real-time communication or mission-critical applications, may be prioritized over less time-sensitive traffic to ensure that essential services are not adversely affected by congestion or overload. The core network applications can allocate available bandwidth among different users, applications, or services based on predefined quotas or usage limits. By limiting the bandwidth available to each entity, throttling helps prevent any single user or application from monopolizing network resources and ensures equitable access for all users.

As noted above, the first and second traffic data volumes can together amount to a traffic volume that is less than or equal to the traffic capacity of the UDR. As a result, by throttling the traffic of the first core network application that is above the first volume of the traffic data and the traffic of the second core network application that is above the second volume of the traffic data, the network load management system can ensure that the total traffic volume does not exceed the traffic capacity of the UDR (e.g., as illustrated in FIG. 4B).

In some implementations, the first core network application is a 5G application and the second core network application is a 4G application. The network load management system can prioritize the transmission of the first volume of the traffic data to the first core network application and the second volume of the traffic data to the second core network application based on predefined criteria. For instance, the network load management system may prioritize the transmission of the first volume of traffic data to the 5G application, recognizing the priority associated with next-generation services and applications. Conversely, the second volume of traffic data may be prioritized for transmission to the 4G application to ensure that both applications receive adequate resources and support to meet their respective needs.

In some implementations, the core network includes a plurality of NFs. The network load management system can monitor the plurality of NFs to detect periodic signals exchanged between NFs within the plurality of NFs. The signals indicate the health and functionality of the NFs, providing insights into the NFs’ availability and responsiveness to network communications. By detecting and analyzing the signals, the network load management system gains information about the operational status of the NFs and the NFs’ respective ability to handle incoming traffic effectively.

In response to detecting the periodic signals, the network load management system can verify an ability of the NFs associated with the detected signal to receive and respond to network communications within the core network. The verification can include conducting checks to ensure that the NFs are capable of receiving and responding to network communications within the core network in an efficient manner (e.g., without being overloaded or reaching capacity). For example, if the tested NF is capable of receiving and responding to network communications within the core network in an efficient manner, the network load management system can continue to assign traffic to the same core network applications of the NF. Alternatively, if the network load management system identifies an issue (e.g., nearing capacity), the network load management system can re-route the traffic to a different core network applications of the NF, or a different NF altogether. By verifying the responsiveness of the NFs, the network load management system can identify any potential issues or bottlenecks that may impact network performance and take proactive measures to address them.

### Computer System

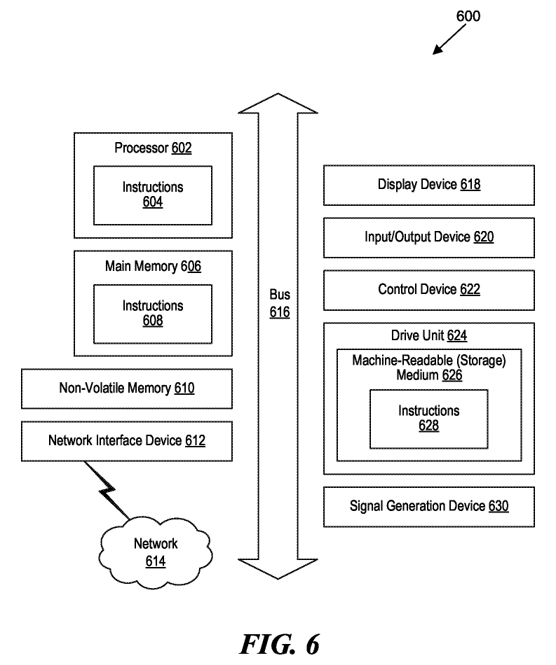

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A non-transitory, computer-readable storage medium comprising instructions recorded thereon, wherein the instructions when executed by at least one data processor of a network management system, cause the system to:
receive, by a network function of a core network, information indicating a capacity of a Unified Data Repository (UDR) of the core network,
wherein the UDR is associated with first core network application and second core network application;
obtain traffic data for the first core network application and the second core network application;
determine, by the network function of the core network, (1) a first volume of the traffic data for the first core network application and (2) a second volume of the traffic data for the second core network application, using the capacity of the UDR,
wherein a sum of the first volume and the second volume is less than or equal to the received capacity of the UDR; and
transmit the first volume of the traffic data to the first core network application and the second volume of the traffic data to the second core network application,
wherein the first core network application throttles traffic through the first core network application that is above the first volume of the traffic data, and
wherein the second core network application throttles traffic through the second core network application that is above the second volume of the traffic data.

2. The non-transitory, computer-readable storage medium of claim 1, wherein the determined first volume of the traffic data is equal to a capacity of the first core network application, wherein the instructions further cause the system to:
prevent transmission of additional traffic data from the network function to the first core network application.

3. The non-transitory, computer-readable storage medium of claim 1, wherein the determined first volume of the traffic data is equal to the determined second volume of the traffic data.

4. The non-transitory, computer-readable storage medium of claim 1, wherein the determined first volume of the traffic data is different from the determined second volume of the traffic data.

5. The non-transitory, computer-readable storage medium of claim 1,
wherein the first core network application is a 5G application,
wherein the second core network application is a 4G application, and
wherein the instructions further cause the system to prioritize the transmission of the first volume of the traffic data to the first core network application and the second volume of the traffic data to the second core network application based on predefined criteria.

6. The non-transitory, computer-readable storage medium of claim 1, wherein the network function receives the information from one or more of: the UDR, the first core network application, or the second core network application.

7. The non-transitory, computer-readable storage medium of claim 1, wherein the core network comprises a plurality of network functions, wherein the instructions further cause the system to:
monitor the plurality of network functions to detect periodic signals exchanged between network functions within the plurality of network functions; and
in response to detecting the periodic signals, verify an ability of the network functions associated with the detected signal to receive and respond to network communications within the core network.

8. A system for managing network load of wireless devices comprising:
at least one hardware processor; and
at least one non-transitory memory storing instructions, which, when executed by the at least one hardware processor, cause the system to:
receive, by a network function of a core network, information indicating a capacity of a Unified Data Repository (UDR) of the core network,
wherein the UDR is associated with first core network application and second core network application;
obtain traffic data to a first core network application and a second core network application;
determine, by the network function of the core network, (1) a first volume of the traffic data to the first core network application and (2) a second volume of the traffic data to the second core network application, using the capacity of the UDR,
wherein a sum of the first volume and the second volume is less than or equal to the received capacity of the UDR; and
transmit the first volume of the traffic data to the first core network application and the second volume of the traffic data to the second core network application,
wherein first core network application throttles traffic through the first core network application that is above the first volume of the traffic data, and
wherein the second core network application throttles traffic through the second core network application that is above the second volume of the traffic data.

9. The system of claim 8, wherein the first volume of the traffic data is equal to a capacity of the first core network application, wherein the instructions further cause the system to:
prevent transmission of additional traffic data from the network function to the first core network application.

10. The system of claim 8, wherein the first volume of the traffic data is equal to the second volume of the traffic data.

11. The system of claim 8, wherein the first volume of the traffic data is different from the second volume of the traffic data.

12. The system of claim 8,
wherein the first core network application is a 5G application,
wherein the second core network application is a 4G application, and
wherein the instructions further cause the system to prioritize transmission of the first volume of the traffic data to the first core network application over the second volume of the traffic data to the second core network application.

13. The system of claim 8, wherein the network function receives the information from one or more of: the UDR, the first core network application, or the second core network application.

14. The system of claim 8, wherein the core network comprises a plurality of network functions, wherein the instructions further cause the system to:
monitor the plurality of network functions to detect periodic signals exchanged between network functions within the plurality of network functions; and
in response to detecting the periodic signals, verify an ability of the network functions associated with the detected signal to receive and respond to network communications within the core network.

15. A method for managing network load of wireless devices comprising:
receiving, by a network function of a core network, information indicating a capacity of a Unified Data Repository (UDR) of the core network,
wherein the UDR is associated with a plurality of core network applications;
obtaining traffic data to each of the plurality of core network applications;
determining, by the network function of the core network, a respective volume of the traffic data to each of the plurality of core network applications, using the capacity of the UDR,
wherein a sum of the respective volumes is less than or equal to the received capacity of the UDR; and
transmitting the respective volumes of the traffic data to a corresponding one of the plurality of core network applications,
wherein each corresponding core network application of the plurality of core network applications throttles traffic through the corresponding core network application that is above the respective volume of the traffic data for the corresponding core network application.

16. The method of claim 15, wherein the respective volume of the traffic data of a particular core network application of the plurality of core network applications is equal to a capacity of the particular core network application, further comprising:
preventing transmission of additional traffic data from the network function to the particular core network application.

17. The method of claim 15, wherein the respective volumes of the traffic data to each of the plurality of core network applications are equal.

18. The method of claim 15, wherein a first volume of the traffic data to a first core network application of the plurality of core network applications is different from a second volume of the traffic data to a second core network application of the plurality of core network applications.

19. The method of claim 15, wherein the network function receives the information from one or more of: the UDR, or at least one core network application of the plurality of core network applications.

20. The method of claim 15, wherein the core network comprises a plurality of network functions, further comprising:
monitoring the plurality of network functions to detect periodic signals exchanged between network functions within the plurality of network functions; and
in response to detecting the periodic signals, verifying an ability of the network functions associated with the detected periodic signal to receive and respond to network communications within the core network.
